(19) United States
(12) Patent Application Publication
(10) Pub. No.: US 2020/0256112 A1
(43) Pub. Date: Aug. 13, 2020

(54) WINDOW CONTROL SYSTEM TO ADJUST WINDOWS OF A NON-MOVING VEHICLE IN RESPONSE TO ENVIRONMENTAL CONDITIONS

(71) Applicant: Michael D. Williams, Newport Beach, CA (US)

(72) Inventor: Michael D. Williams, Newport Beach, CA (US)

(21) Appl. No.: 16/271,693

(22) Filed: Feb. 8, 2019

(51) Int. Cl. E05F 15/71; E05F 15/73

(52) U.S. Cl. CPC E05F 15/71; G01W 1/02; E05Y 2900/55; E05F 15/73

(57) ABSTRACT

A computer program product, system, and computer-implemented method for adjusting a window of a non-moving vehicle, the method including receiving input data from at least one sensor associated with the non-moving vehicle, determining the input data satisfies activation conditions, and adjusting a window of the non-moving vehicle in response to the determination that the input data satisfies the activation conditions.

### FIELD

This disclosure concerns generally methods and systems for adjusting windows of a non-moving vehicle to reduce cabin temperature of the non-moving vehicle.

### BACKGROUND

When a vehicle is not moving (e.g., parked), the temperature inside the vehicle may rise to temperatures that greatly exceed the temperature outside. A vehicle parked outside on a hot day can turn into a scorching oven. Within one hour, the temperature inside of a vehicle parked in the sun on a day that is 95 degrees Fahrenheit (F) can reach over 115 degrees F. Even vehicles parked in the shade on a hot day can reach an inside temperature of more than 100 degrees F.

Children and pets may be inadvertently left inside parked vehicles by accident from time to time. This may lead to dangerous situations that may result in injury or death of the children and/or pets on warm days, especially when the windows of the parked vehicles are in a closed position. Most of the time, windows of the vehicles are closed to prevent theft and/or outside elements such as insects, water and pollutants from entering the parked vehicle. However, when the windows of the parked vehicle are in a closed position on warm days, the internal cabin temperature of the parked vehicle may rise to be considerably hotter inside the cabin of the parked car than the temperature outside.

Even on a relatively cool and/or cloudy day, the temperature inside a parked car can quickly spike to life-threatening levels in certain situations, e.g., due to the greenhouse effect. Therefore, there is a need for improved systems and methods to minimize the risk and dangers associated with an increase in internal cabin temperature of a non-moving vehicle.

### SUMMARY

Embodiments of the present disclosure provide systems and computer-implemented methods for adjusting a vehicle window of a non-moving vehicle. The method includes receiving input data from at least one sensor associated with the non-moving vehicle. The method also includes determining the input data satisfies activation conditions. The method further includes adjusting the at least one window of the non-moving vehicle in response to the determination that the input data satisfies the activation conditions.

In one embodiment, a vehicle window control system includes a computer processor to execute a set of program code instructions, and a memory to hold the set of program code instructions. The set of program code instructions may include program code to receive, from a temperature sensor of a non-moving vehicle, data representing a cabin temperature of the non-moving vehicle. The set of program code instructions may also include program code to determine if the cabin temperature exceeds a threshold temperature. The set of program code instructions may also include program code to adjust a window of the non-moving vehicle based at least in part on the determination that the cabin temperature exceeds the threshold temperature.

In another embodiment, a system is disclosed to reduce cabin temperature of a non-moving vehicle. The system includes a plurality of power windows, one or more window position sensors configured to sense one or more window positions of respective windows of the non-moving vehicle, a power window controller configured to control the power windows, an internal temperature sensor configured to sense a cabin temperature of the non-moving vehicle, and a control module coupled to the window position sensors, the power window controller, and the internal temperature sensor such that the control module is configured to receive, from the internal temperature sensor, the cabin temperature of the non-moving vehicle. The control module is also configured to determine if the cabin temperature exceeds a threshold temperature, and to open the plurality of power windows based at least in part on a determination that the cabin temperature exceeds the threshold temperature.

Further details of aspects, objects and advantages of the disclosure are described below in the detailed description, drawings and claims. Both the foregoing general description and the following detailed description are exemplary and explanatory, and are not intended to be limiting as to the scope of the disclosure.

### BRIEF DESCRIPTION OF THE DRAWINGS

The drawings illustrate the design and utility of embodiments of the present disclosure, in which similar elements are referred to by common reference numerals. In order to better appreciate the advantages and objects of embodiments of the disclosure, reference should be made to the accompanying drawings. However, the drawings depict only certain embodiments of the disclosure, and should not be taken as limiting the scope of the disclosure.

The drawings may use like reference numerals to identify like elements. A letter after a reference numeral, such as “120a,” indicates that the text refers specifically to the element having that particular reference numeral. A reference numeral in the text without a following letter, such as “120,” refers to any or all of the elements in the drawings bearing that reference numeral (e.g. “120” in the text refers to reference numerals “120a” and/or “120b” in the drawings).

FIG. 1 illustrates a view of a vehicle in which some embodiments of the disclosure are implemented.

FIG. 2 is a block diagram of a system suitable for implementing an embodiment of the present disclosure.

FIG. 3 is a flow chart for adjusting windows of a non-moving vehicle, according to some embodiments of the present disclosure.

FIG. 4 is a block diagram of a computer system suitable for implementing an embodiment of the present disclosure.

### DETAILED DESCRIPTION OF THE EMBODIMENTS OF THE DISCLOSURE

Various embodiments are described hereinafter with reference to the figures. The figures are not necessarily drawn to scale. The figures are intended to facilitate the description of the embodiments, and are not intended as an exhaustive description of the disclosure or as a limitation on the scope of the disclosure. In addition, an illustrated embodiment need not have all the aspects or advantages shown. An aspect or an advantage described in conjunction with a particular embodiment is not necessarily limited to that embodiment and can be practiced in any other embodiments even if not so illustrated. References throughout this specification to “some embodiments” or “other embodiments” suggests that a particular feature, structure, material, or characteristic described in connection with the embodiments is included in at least one embodiment. Thus, use of “in some embodiments” or “in other embodiments” in various places throughout this specification does not necessarily refer to the same embodiment or embodiments.

The present disclosure provides an improved system and approach for adjusting (e.g., automatically) the window(s) of a non-moving vehicle based typically on an internal temperature of a passenger cabin of the non-moving vehicle. A vehicle is non-moving if it is in “Park,” its emergency brake is engaged, its wheels are not rotating, its engine is off, and/or its GPS location is constant. Any of these conditions may be determined using existing on-board systems and/or additional systems designed specifically for use with a window control system as described herein. Further, systems as described herein may be implemented to activate on determination of one or more of only a subset of the above-mentioned conditions, as opposed to one or more of any of the conditions. In one or more embodiments, the window(s) of the non-moving vehicle are adjusted (e.g., partially opened, fully opened, partially closed, or fully closed) when an internal temperature of the passenger cabin reaches a threshold temperature. The threshold temperature may be pre-defined, pre-determined, preset, programmable, user-defined, dynamically adjusted based on other environmental factors (e.g., outside temperature), set by GPS-location data, set by GPS-obtained weather data, or determined in any other way. The adjustment(s) are made so that the internal temperature of the passenger cabin may be reduced inside the non-moving vehicle. In some embodiments, after a threshold amount of time has passed where the internal cabin temperature continues to exceed the threshold temperature, the window(s) may be fully opened (or closed depending on the situation) and additional alerts may be raised (e.g., sounding the vehicle's horn, flashing the vehicle's light(s), sending notifications to a user and/or local authorities).

In some embodiments, a plurality of sensors may be used individually and/or in combination to determine whether activation conditions are satisfied to take actions (e.g., adjust the windows) to mitigate possible life-threatening scenarios. In some embodiments, the window(s) of the non-moving vehicle may be automatically adjusted based on conditions external to the internal cabin of the non-moving vehicle. For example, opened windows may be automatically closed if rain is detected. In some embodiments, the adjustment of the windows may be determined by a combination of external and internal conditions. For example, if the temperature difference between the external temperature and internal temperature exceeds a threshold, or if the internal temperature is at a non-comfortable temperature for humans and animals, and adjusting the window(s) can help to improve the conditions within the internal cabin of the vehicle, then the window(s) may be adjusted accordingly to compensate for the difference between external and internal temperature. In some embodiments, if it is freezing cold outside but warm inside the cabin of the non-moving vehicle, the windows will not be opened, but instead, closed, especially when it is determined that there is a living being inside the cabin. In other embodiments, if an external temperature exceeds a threshold temperature but the internal temperature does not exceed the threshold temperature, and a living being is detected within the cabin, then the windows may not be opened, but instead, closed to prevent excess external heat from entering the vehicle cabin. In some embodiments, the window(s) may be opened if movement is detected inside a cabin of the non-moving vehicle and the internal temperature of the cabin exceeds a threshold temperature, either at a single point in time or for a threshold duration. In some embodiments, the window(s) may be closed based on external conditions such as rain and/or snow, especially with the internal temperature of the cabin does not exceed the threshold temperature.

In some embodiments, if windows are in an open position and a rain sensor detects rain, the vehicle window control system may close the windows if no living being is inside the vehicle cabin regardless of an internal temperature of the vehicle cabin. If a living being is inside the vehicle cabin and the internal temperature of the vehicle cabin is below the threshold, the vehicle window control system may close the windows as well. Otherwise, one or more windows may stay down or remain in an open position. For example, only the rear windows may stay down while the front windows are raised up to a close position due to expensive electronics located in driver door or front seat area.

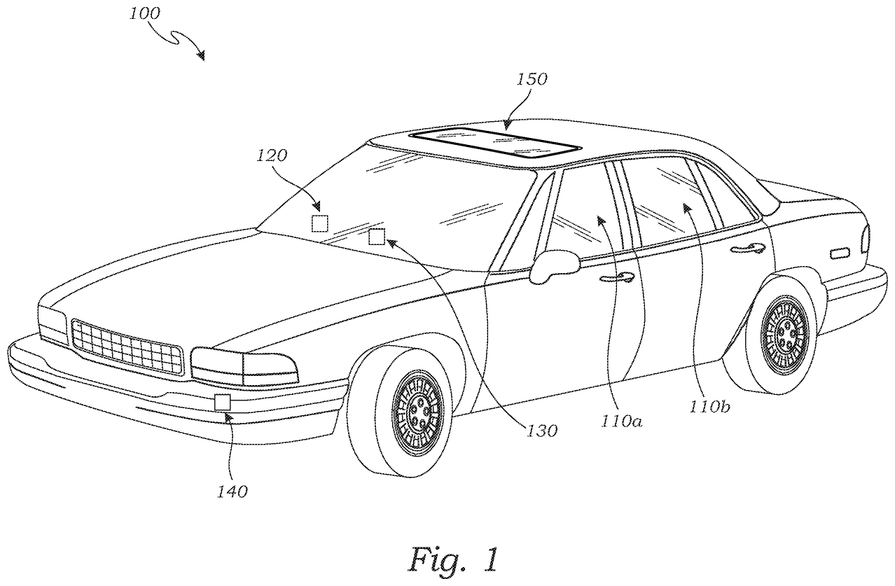

FIG. 1 illustrates a view of a vehicle 100 in which some embodiments of the disclosure are implemented. FIG. 1 illustrates a typical operating environment for a system for adjusting the window(s) of a non-moving (e.g., parked) vehicle 100 based at least on an internal temperature of a passenger cabin of the non-moving vehicle. In practice, the technique and concepts described herein can be applied to other vehicle configurations, and the description of vehicle 100 is not intended to be limiting or restrictive in any way. For example, the systems and methods of the present disclosure may be applicable to vehicles such as airplanes, buses, boats, etc. For purposes of simplifying the explanation of the present disclosure, a non-moving automobile, such as the vehicle 100 will be used as an example.

Vehicle 100 includes power windows 110 and an internal temperature sensor 120. Power window 110a is the left front window and power window 110b is the left rear window. Vehicle 100 may also include other power windows (not shown) such as the front right window, rear right window, sliding door windows, hatchback windows, cab windows, sunroofs, etc., or other power openings such as a roof on a convertible. Each power window is configured to allow a user to adjust the positions. The general operation and control of power windows 110 are well-known.

The internal temperature sensor 120 may be an in-car/in-cabin temperature sensor. In some embodiments, the internal temperature sensor 120 may be located in an aspirator. A small amount of in-car air may be drawn through the aspirator across the in-car sensor to provide an average in-car temperature data to a processor. The internal temperature sensor 120 should be extremely sensitive to slight variation in temperature. In some embodiments, the internal temperature sensor 120 may be a resistor with its resistance value determined by its temperature. The change in the resistance value of each internal temperature sensor 120 is inversely proportional to the change in temperature. This type of resistor is called a thermistor. The internal temperature sensor 120 may continuously monitor an internal temperature of an inside cabin of the vehicle 100 even when the vehicle is parked with the engine and power turned off. The internal temperature sensor 120 may operate in a low power mode so that it may continue to operate using the vehicle's primary electric power source (e.g., a vehicle battery) once the vehicle's power engine and power has been shut off. In some embodiments, vehicle 100 may include an additional/alternative electric power source such as, for example, a second battery, solar panel, fuel cell, etc. so that the internal temperature sensor 120 may continue to operate even when the non-moving vehicle's engine and power has been turned off. In some embodiments, vehicle 100 may be an electric vehicle such that the battery that powers the electric vehicle may be the energy source to power the sensors and the control modules of the vehicle to power embodiments of the present disclosure.

Vehicle 100 may also include one or more internal sensor(s) 130 to assist in determining if a living being (e.g., a small child, a small animal, an elderly person, etc.) is inside the vehicle 100. For example, the internal sensor(s) 130 may include as least one of, as examples, an infrared sensor (IR), a passive infrared (PIR) sensor, a MicroWave (MW) sensor, a motion sensor, an area reflective type sensor, an ultrasound/ultrasonic sensor, a vibration sensor, a sonar range finder sensor, a CO2 sensor, a webcam/camera, a Kinect Face/face ID sensor, a pressure sensor in the front and/or seats, and/or a microphone.

A PIR sensor works on heat difference detection, measuring infrared radiation. Inside the PIR device is a pyroelectric sensor that can detect the sudden presence of objects (e.g., a living being) which radiate a temperature different from the temperature of a background, such as a temperature of the cabin of vehicle 100. The PIR detects body heat (infrared energy) to determine if there is motion in the cabin. The PIR can detect heat and movement in a surrounding area by creating a protective grid. If a moving object blocks too many grid zones and the infrared energy levels change rapidly, the sensors are tripped.

A microwave (MW) sensor sends high frequency sound waves and will check for their reflected patterns. If the reflected pattern is changing continuously then it assumes that there is occupancy. MW sensors cover a larger area than infrared sensors, but they are vulnerable to electrical interference. Dual Technology motion sensors can have combined features in an attempt to reduce false alarms. For example, a passive infrared (PIR) sensor could be combined with a MW sensor. Since each operates in different areas of the spectrum, and one is passive and one is active, Dual Technology motion sensors are not as likely as other types to cause false alarms, because in order for the motion to be detected, both sensors have to be tripped.

Area reflective type sensors emit infrared rays from an LED. Using the reflection of those rays, the sensor measures the distance to the person or object and detects if the object is within the designated area. Ultrasound/ultrasonic sensors will send high frequency sound waves and will check for their reflected patterns. If the reflected pattern is changing continuously then it assumes that there is occupancy. A vibration sensor uses a small mass on a lever, which is activated by a switch when it vibrates. A sonar range finder finds objects (e.g., a living being) using a speaker that sends out a sound wave and a microphone that then measures how long it takes for the sound wave to come back. The longer the sound wave takes to come back, the further away the object. If a living being is moving slightly in the cabin of vehicle 100, the sonar range finder may determine different distances for the object, thus detecting a living being.

CO2 sensors can detect a change in a vehicle's cabin environment due to the presence of a living being. Kinect Face/face ID technology may detect living beings based on facial identification technologies. Pressure sensors may be installed in the front and/or rear seat, similar to the ones used to activate airbags within a vehicle 100. Microphones, which may be installed in vehicle 100, as an example, for hands free phone operations, may be configured to listen for sounds of a living being inside vehicle 100, such as a baby babbling, a baby talking, a baby moaning, a baby crying, a child screaming, a dog panting, a dog whining, a dog barking, a cat meowing, etc. Although various types of internal sensors have been disclosed, one of ordinary skill in the art may appreciate other types of sensors may also be used singly, or in combination, with other sensors to detect a living being present inside, as an example, a cabin of a vehicle. Also, in some embodiments, a single and/or a combination of the internal sensor(s) 130 may be used to provide data to a control module to determine whether or not a living being is present inside the passenger cabin of a vehicle.

Vehicle 100 may also include one or more external sensors 140 for detecting, for example, rain, external temperature, submersion of vehicle under water, etc. The external sensors 140 may include intermittent windshield wiper sensors that can detect rain on the windshield. External sensors 140 may also include cameras used for cruise control, self-driving, lane changing, and backup that are configured to also detect rain. Parking sensors may be also be configured to identify rain. An onboard computer of vehicle 100 may receive weather notifications to also help the overall system detect external conditions such as rain, snow, etc. Humidity or other water-detecting sensors may also be configured onto vehicle 100 to detect rain, snow, etc. In some embodiments, external sensors 140 may also include a sensor for detecting the vehicle 100 being submerged in water. Example sensors may include a pressure switch or pressure transducer, a capacitive proximity sensor, and/or an optical sensor that refracts light internally in air, but the light beam is lost into the fluid if it is immersed in water. The internal and external sensors may be located in or on the vehicle in various locations, depending on the specific vehicle design and specifications.

In some embodiments, the vehicle 100 may also include a sunroof 150 that may be power-controlled like the power windows 110. The sunroof 150 may be adjusted similar to the power windows 110 for opening and closing the sunroof 150 based on received input data from the sensors to determine activation conditions to activate the sunroof 150 and/or the one or more power windows. In some embodiments, a moon roof (not shown) may be power-controlled like the power windows 110. The moon roof may be adjusted similar to the power windows 110 for opening and closing the moon roof based on received input data from the sensors to determine activation conditions to activate the moon roof and the one or more power windows accordingly. When “window” is used herein, this includes sunroofs 150, moon roofs, hatchback windows, etc.

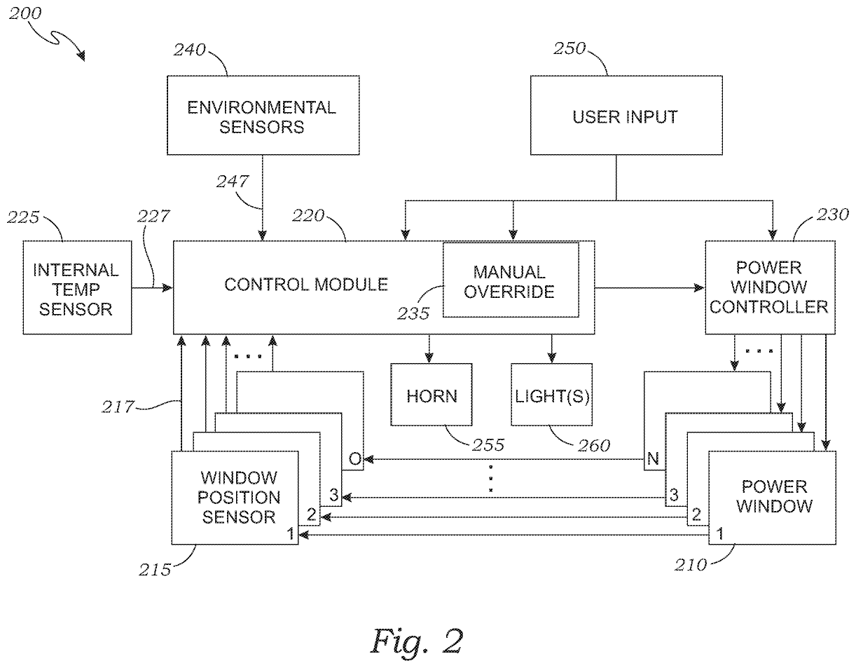

Turning now to FIG. 2, a block diagram is shown of a system 200 suitable for implementing an embodiment of the present disclosure. System 200 generally includes a plurality of power windows 210, a window controller 230 coupled to power windows 210, a plurality of window position sensors 215 such that each window position sensor 215 is coupled to a respective power window 210, an internal temperature sensor 225, and a control module 220. An embodiment of system 200 may also include additional environmental sensors 240. Environmental sensors 240 may include one or more types of internal sensor(s) 130 configured to operate independently or in conjunction with other sensors (e.g., internal temperature sensor 225) to detect a living being present inside a vehicle and/or external sensors such that internal sensors may detect a living being occupying/present within a cabin of a vehicle and external sensors may detect a presence of rain and/or snow that is external to a vehicle cabin. An embodiment of system 200 may also include a manual override 235 and/or a user input 250.

Control module 220 may be coupled to the various features and components using suitable data communication links and suitable data communication protocols. System 200 may work in conjunction with a vehicle's power windows system or may be incorporated into the vehicle's power window system. Control module 220 may be implemented or performed with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. A processor may be realized as a microprocessor, a controller, a microcontroller, or a state machine. A processor may also be implemented as a combination of computing devices, e.g., a combination of a digital signal processor and a microprocessor, a plurality of microprocessors, one or more microprocessors in conjunction with a digital signal processor core, or any other such configurations. In practical embodiments, control module 220 is implemented in an electronic control module (ECM) of the host vehicle.

For simplicity, the following description assumes that system 200 employs a single user input 250. In practice, system 200 can utilize any number of user inputs 250. User input 250 is configured to provide data representing a user's command. The user's command may be realized as the manual actuation of a button, switch, a voice command, or any other such human action intended to achieve a desired result. User input 250 sends data to power window controller 230 in a format understood by the power window controller 230. A typical vehicle deployment will include N user inputs 250 (such as buttons or switches) that respectively correspond to N power windows 210. In other words, each power window 210 can be controlled by respective assigned user input 250. In some embodiments, a user (e.g., a driver and/or a passenger) may press a button that is programmed such that a single action initiated by the user lowers one or more windows by X inches and/or cracks open a sunroof and/or moon roof. In some embodiments, the button may be a power window control button. In another embodiment, the button may be a special button designated to lower the one or more windows by X inches, wherein X is a configurable parameter or a default parameter that is configurable to an amount of distance or percentage of movement of the window. In another embodiment, the button may be on a vehicle-specific software application on a cell phone, on-board computer, or external computer, designed to remotely open, via Internet, Wi-Fi, Bluetooth, NFC, etc., one or more windows by a preset range.

FIG. 2 depicts a system 200 in a configuration that utilizes N power windows 210. For a typical vehicle, an embodiment of system 200 may be a vehicle window control system that includes one or more power windows 210 (e.g., four windows such as front left, front right, rear left, and rear right). Each window of power windows 210 is an unfixed window capable of being opened and closed. Each power window 210 is coupled to a power window regulator (not shown in FIG. 2) where the power window regulator is configured to mechanically reposition the associated power window. Each power window regulator may be implemented as an electrically or pneumatically-operated device, or as any other powered devices utilized to reposition the power window.

Power window controller 230 is configured to control the opening and closing of power windows 210. In practice, power window controller 230 receives data from user inputs 250 and controls the repositioning of power windows 210 accordingly. As described in more detail below, power window controller 230 may also be suitably configured to support automatic power window repositioning to alleviate heat within the vehicle cabin or to minimize/prevent rain from entering the vehicle cabin.

Window position sensors 215 are configured to generate window position data 217 corresponding to current positions of power windows 210, and may be realized as any suitable source that provides current window position data to system 200. In practice, window position sensors 215 may be implemented in power windows 210 and/or in power window controller 230, or in any other subsystem in which the window positions can be detected. The window position data 217 may indicate, for example, a percentage relative to the fully closed (e.g., 100%=closed, and 0%=open) or the fully opened (e.g., 100%=open, and 0%=closed) position, or a distance relative to the fully closed position, the fully opened position, or any reference position. This embodiment of system 200, as depicted in FIG. 2, has O window position sensors 215. In practice, system 200 can use any number of window position sensors. Since system 200 need not require knowledge of the position of each power window to function properly, some power windows may not be associated with a window position sensor (e.g., O need not equal N). Window position sensors 215 send window position data 217 to control module 220 in a format that can be understood by control module 220.

Internal temperature sensor 225 (e.g., a sensor that detects a temperature of the vehicle cabin) is configured to generate vehicle cabin temperature data 227 corresponding to the internal cabin temperature of the vehicle, and may be any suitable source that provides the vehicle's current internal temperature of the vehicle's cabin to control module 220. Internal temperature sensor 225 sends vehicle cabin temperature data 227 to control module 220 in a format that can be understood by control module 220.

Environmental sensors 240 are configured to generate environmental data 247. Environmental data 247 may include internal sensor data and external sensor data. Internal sensor data includes a set of data generated from internal sensors (e.g., internal sensor(s) 130) used to determine if a living being is inside the vehicle 100, as discussed above). External sensor data includes a set of data generated from external sensors (e.g., external sensor(s) 140) for, as an example, rain detection data, outside air temperature data, windshield wiper status data, and/or any other data representing the vehicle's current physical external environment or vehicle state. In some embodiments, an environmental sensor 240 can be realized as a motion detector sensor that generates data representing a living being present inside a vehicle. Such a motion detector sensor can be used by system 200 to determine when a living being is present within the non-moving (e.g., parked) vehicle. Environmental sensors 240 may be any suitable source or sources that provide data in a format that can be understood by the control module 220.

Control module 220 is coupled to power window controller 230, window position sensors 215, and internal temperature sensor 225. As disclosed in more detail below, control module 220 is generally configured to receive window position data 217 from the window position sensors 215, vehicle cabin temperature data 227 from the internal temperature sensor 225, and environmental data 247 from the environmental sensors 240 (e.g., internal sensors 130), to process the sensor data, and to instruct power window controller 230 to reposition one or more power windows 210 to respective non-closed positions if it is determined that there is a living being present within the non-moving (e.g., parked) vehicle and that the internal temperature of the vehicle exceeds a threshold temperature. In some embodiments, control module 220 may be configured to receive window position data 217 from the window position sensors 215 and environmental data 247 from the environmental sensors 240 (e.g., external sensor 140 for detecting rain), to process sensor data, and to instruct the power window controller to reposition one or more power windows 210 to respective closed positions if it is determined that rain is detected and that the one or more power windows 210 are in a non-closed position.

Control module 220 is configured to determine, as a function of window position data 217, vehicle cabin temperature data 227 and environmental data 247, whether to instruct power window controller 210 to reposition one or more power windows 210 to particular non-closed positions, wherein each of the particular non-closed positions is a function of window position data 217 and vehicle cabin temperature 227.

In response to user input 250, manual override 235 may allow a user to temporarily disable further instructions by control module 220 to automatically reposition power windows 210. Manual override 235 may be initiated by the use of a manual override command. A manual override command may be issued when an occupant of the vehicle provides user input 250. In one particular embodiment, user input 250 is provided by the manual actuation by the user of a power window control switch, made in the user's effort to manually adjust the position of a power window 210. Manual override 235 may be configured such that after control module 220 instructs power window controller 230 to reposition a power window 210 to a particular non-closed position, if the user then utilizes user input 250 to further adjust the power window, then manual override system 235 prevents control module 220 from issuing further commands to automatically reposition the power window (or, alternatively, any power window). In some embodiments, user input 250 may include a driver pressing a preconfigured button such that in the single action, the one or more windows may be lowered by X inches and/or the sunroof may be opened by X inches, wherein X is a configurable number.

In some embodiments, user input 250 may activate the control module 220 to factory-installed safety defaults. Factory-installed safety defaults for a parked vehicle may include, for example, internal sensors providing environmental data 247 indicating a living being is present inside the parked vehicle and internal temperature sensor 225 providing vehicle cabin temperature 227 to determine, by the control module 220, that the vehicle cabin temperature 227 exceeds a threshold temperature. Upon determination that the vehicle cabin temperature 227 exceeds the threshold temperature and that a living being is present inside the parked vehicle, the control module 220 may take at least one of the following actions: (1) lower the one or more power windows 210 from a particular amount to completely opening all of the one or more power windows 210; (2) turn on air conditioning; (3) activate the horn 255; (4) sound an external alarm (not shown); (5) activating (e.g., turning on, blinking, and/or flashing) lights 260 of the vehicle (e.g., hazard lights, headlights, brake lights, turning signal lights, internal lights, alarm lights, etc.); or (6) activate a vehicle communication system to perform at least one of (a) send text to owner, (b) call owner to provide details about current situation, (c) send notifications to an application loaded on a mobile phone of the owner of the vehicle, or (d) call 911, fire or police departments.

In some embodiments, user input 250 for initiating passive heat removal mode (e.g., a “windows cracked mode” which corresponds to a mode that automatically opens the one or more windows of the vehicle to allow heat from inside the cabin of the vehicle to escape) may include: (1) a user pressing a dedicated window activator button to initiate the “windows cracked mode”; (2) a user pressing an existing window actuator button in certain ways to initiate the “windows cracked mode” such that the certain ways may include: (a) single short press halfway down, (b) single half quarter press, (c) double click window activator button, (d) double click window activator button up (e.g., close mode) when windows are already closed, or (e) clicking a combo of Left and Right front windows simultaneously; (3) user controlled settings in the vehicle's computer(s) to set a threshold temperature such that when the internal cabin temperature of the vehicle exceeds the threshold temperature, lower the windows and/or open the sunroof, moon roof, hatchback, cab window, roof of a convertible, etc.; and/or (4) remotely activating the passive heat removal mode by software application, mobile phone, or computer.

In some embodiments, system 200 may also include a power lock controller (not shown in FIG. 2) for controlling power locks of the doors and/or convertible roof of vehicle 100. The doors of vehicle 100 may include a front driver side door, front passenger side door, rear driver side door, a rear passenger side door, sliding doors, hatchback doors, custom doors, etc. In some embodiments, the power lock controller may unlock the associated locks in addition to and/or instead of adjusting windows, so that emergency personnel or others from outside the vehicle, or those inside the vehicle, may open the doors more easily.

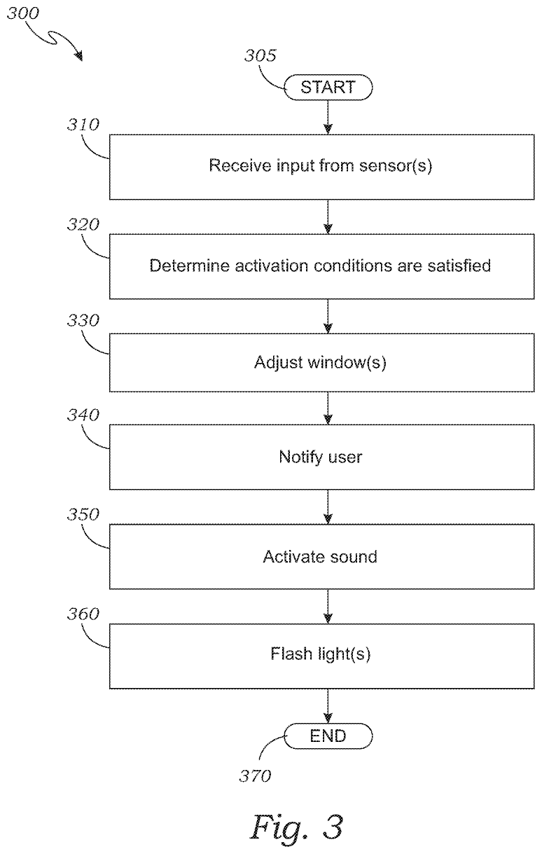

Turning now to FIG. 3, a flow chart is shown for adjusting windows of a non-moving vehicle, according to some embodiments of the disclosure. It should be appreciated that a practical system for adjusting windows of a non-moving vehicle may use a different processing algorithm (or algorithms) and that method 300 is merely one example algorithm. The various tasks performed in connection with method 300 may be performed by software, hardware, firmware, or any combination thereof. For illustrative purposes, the following description of process 300 may refer to elements mentioned above in connection with FIGS. 1-2. In practical embodiments, portions of method 300 may be performed by different elements of the described system, e.g., control module 220 or power window controller 230. It should be appreciated that method 300 may include any number of additional or alternative tasks, and method 300 may be incorporated into a more comprehensive procedure or process having additional functionality not described in detail herein.

For this example, automatic repositioning method 300 operates on four power windows located on the sides of a vehicle: left front window (e.g., power window 110a), left rear window (e.g., power window 110b), right front window (not shown), and right rear window (not shown). Some embodiments may include a sunroof, moon roof, power sliding window (e.g., cab of a truck), etc., as one of the power windows. Some embodiments may include any type of power-operated window or door capable of being controlled by a controller (e.g., a convertible roof top, a power operated rear hatch, a power operated door, etc.)

The method begins at Step 305. At Step 310, input data is received from one or more sensors associated with the non-moving vehicle. The input data may include window position data 217 from window position sensors 215, vehicle cabin temperature data 227 from internal temperature sensor 225, and environmental data 247 from internal sensor(s) 130. The input data may also include data from external sensor(s) 140 for detecting rain, as discussed above in FIG. 1. The window position data 217 received from the window position sensors 215 may include information pertaining to window positions of each of the power window(s) 210 as disclosed above. In some embodiments, one window position sensor 215 may be configured to detect window positions of all of the power window(s) 210. The vehicle cabin temperature data 227 received from the internal temperature sensor 225 corresponds to the internal cabin temperature of the vehicle. The environmental data 247 received from the internal sensor(s) 130 may correspond to data indicative as to whether a living being is present within the vehicle. For example, any of the internal sensor(s), singly or in combination, may be configured to detect whether a living being is present within the vehicle as discussed above. One of ordinary skill in the art may appreciate that in some embodiments, it may be applicable to adjust windows in a vehicle whether there is a living being present inside or not. In some embodiments, it may be applicable to adjust the windows in the vehicle only if there is a living being present inside the vehicle.

At 320, the input data is analyzed to determine if the input data satisfies activation conditions. Activation conditions are situations or circumstances, based on analysis of data, to determine if action should or should not be taken based on the data analyzed. Such situations may consist of a single condition (e.g., cabin temperature exceeds a threshold), or multiple conditions (e.g., temperature exceeds a threshold and movement is detected inside the vehicle cabin). Other activation conditions may include: movement is detected inside the vehicle cabin and a threshold amount of time has passed with the cabin temperature exceeding the threshold temperature; or rain being detected by a rain sensor (e.g., external sensor 140) and the window position data 217 indicating that one or more power window(s) 110 are in an open position. This list of activation conditions is not limiting and additional activation conditions may be considered to activate certain mechanical/logical controls based on the input data received from the one or more sensors.

At 330, once it is determined that the input data satisfies activation conditions, the one or more power window(s) of the non-moving vehicle may be adjusted. Adjusting the one or more power window(s) may include opening the windows (partially or fully) from either a fully-closed position or an already partially open position to release heat from inside the non-moving vehicle when it is determined that the internal temperature of the non-moving vehicle exceeds a threshold. In some embodiments, the one or more power windows may be adjusted if it is also determined that there is a motion inside the non-moving vehicle, which would be indicative of the presence of a person or an animal. In some embodiments, adjusting the window(s) may include adjusting only one of the one or more power windows. In some embodiments, adjusting the window(s) may include adjusting a set of the one or more power windows. In some embodiments, adjusting the window(s) may include adjusting all of the one or more power windows.

In some embodiments, adjusting the windows may include closing the one or more power windows based on the activation conditions. For example, the input data may include environmental data 247 received from external sensors 140 (e.g., rain detection sensors) that indicates rain, and internal sensors 130 representing presence of a living being inside the cabin. Additionally, the input data may include window position data 217 received from window position sensor(s) 215 that indicate one or more power windows may be in an open position. It may then be determined that since rain is detected, one or more windows are in an open position (e.g., satisfies activation conditions), and no living beings are present inside the non-moving vehicle, the one or more open windows may be adjusted to be in a fully closed position so that the inside cabin of the non-moving vehicle may be protected from rain entering. However, in some embodiments when it is determined that there are living beings present inside the cabin of the non-moving vehicle, the one or more open windows may not be closed even if rain is detected.

For example, if it is determined that the inside cabin temperature exceeds a threshold temperature, then the one or more windows may not be closed because of the detection of rain. Instead, the one or more windows may even be adjusted to an open position to release heat from inside the cabin over the possible effect of rain entering the cabin of the vehicle. However, in some embodiments, even if there is a living being present inside the vehicle and rain is detected, the one or more open windows may be closed to prevent the effect of rain entering the cabin of the vehicle when it is determined that the internal temperature of the inside cabin does not exceed the threshold temperature. One of ordinary skill in the art may appreciate that many different activation conditions may be determined to adjust the one or more windows to either open or close, fully or partially, and that the disclosed activation conditions are merely examples.

In some embodiments, adjusting the windows may also include adjusting one or more openings or vents, similar to windows that auto manufacturers may design into the vehicle for the purpose of increased ventilation of the vehicle's cabin. In some embodiments, in response to the input data satisfying activation conditions, a fan may be activated wherein the fan draws heat out of the vehicle from one section of the vehicle and pulls outside air in through the windows, the sunroof and/or or the vents.

After Steps 310-330, additional optional steps may be performed. Any combination of these additional steps may be performed independently of each other, and in any order. At Step 340, once the one or more power window(s) of the non-moving vehicle are adjusted, a notification may be sent to a user. The notification may include at least one of an email, a text message, and/or an alert/notification to a mobile application or device. The user may be an owner of the vehicle, a driver of the vehicle, or anyone else. In some embodiments, a notification having the vehicle's identification information, GPS-location, and/or the activation conditions may be made to 911 to alert fire or police personnel for emergency assistance. At Step 350, a sound component of the non-moving vehicle (e.g., a horn, external vehicle security alarms, etc.) may be activated. This might be desirable, e.g., if the cabin temperature has exceeded a threshold temperature (e.g., 90 degrees F.) for a threshold amount of time (e.g., two minutes), and a person or animal has been detected in the non-moving vehicle. The threshold temperature may be determined in any suitable manner as earlier stated, and likewise the threshold time may be determined in any suitable manner. Sounding the horn, alarm, etc., could help attract attention of people in the vicinity of the vehicle so that they may be able to provide aide if needed.

At Step 360, one or more light(s) of the non-moving vehicle may be flashed or otherwise activated continuously or for a certain period of time. The lights may include the vehicle's headlights, directional lights, brake lights, hazard lights, or internal cabin lights. This could help attract attention of people in the vicinity of the vehicle so that they may be able to provide aide if needed. In some embodiments, one or more doors may be automatically unlocked as well or instead of activating sound and/or light features. The method ends at Step 370.

In some embodiments, the windows of a non-moving vehicle may be configured to automatically fully or partially open to allow exit of the vehicle if it is determined the vehicle is submerged or sinking in water. For example, an external sensor 140 that is configured to detect if the vehicle is submerged or sinking under water (as discussed above), may provide environmental data to a control module. An activation condition may be configured within the control module to instruct the power window controller to open the windows of the vehicle upon detection that the vehicle is submerged under water. In some embodiments, the windows (and/or doors) may not be opened until it is determined that the vehicle is submerged under to a threshold depth which could be determined by pressure sensors or other suitable means. In some embodiments, the windows (and/or doors) may be opened immediately upon determination that the vehicle is submerged. In some embodiments, the activation may be configured to close all of the windows to prevent water from coming into the vehicle cabin.

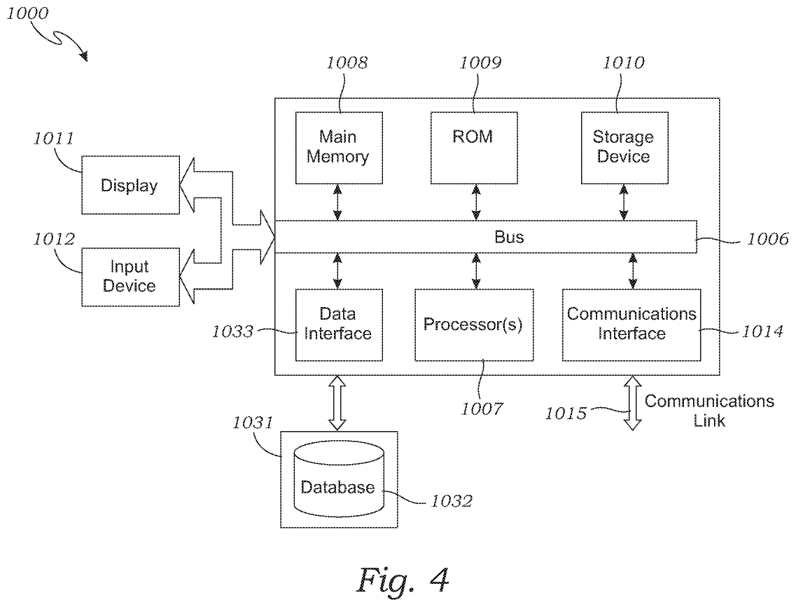

Turning now to FIG. 4, a block diagram is shown of an illustrative computing system 1000 suitable for implementing an embodiment of the present disclosure. Computer system 1000 includes a bus 1006 or other communication mechanism for communicating information, which interconnects subsystems and devices, such as processor 1007, system memory 1008 (e.g., RAM), static storage device 1009 (e.g., ROM), disk drive 1010 (e.g., magnetic or optical), communication interface 1014 (e.g., modem or Ethernet card), display 1011 (e.g., CRT or LCD), input device 1012 (e.g., keyboard), data interface 1033, and cursor control.

According to some embodiments of the disclosure, computer system 1000 performs specific operations by processor 1007 executing one or more sequences of one or more instructions contained in system memory 1008. Such instructions may be read into system memory 1008 from another computer readable/usable medium, such as static storage device 1009 or disk drive 1010. In alternative embodiments, hard-wired circuitry may be used in place of or in combination with software instructions to implement the disclosure. Thus, embodiments of the disclosure are not limited to any specific combination of hardware circuitry and/or software. The term “logic” means any combination of software, firmware, and hardware used to implement all or part of the disclosure. The term “computer readable medium” or “computer usable medium” as used herein refers to any medium that is used to participate in providing instructions to processor 1007 for execution. Such a medium may take many forms, including but not limited to, non-volatile media and volatile media. Non-volatile media includes, for example, optical or magnetic disks, such as disk drive 1010. Volatile media includes dynamic memory, such as system memory 1008. Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the disclosure, execution of the sequences of instructions to practice the disclosure is performed by a single computer system 1000. According to other embodiments of the disclosure, two or more computer systems 1000 coupled by communication link 1015 (e.g., LAN, PTSN, or wireless network) may perform the sequence of instructions required to practice the disclosure in coordination with one another.

Computer system 1000 may transmit and receive messages, data, and instructions, including program, e.g., application code, through communication link 1015 and communication interface 1014. Received program code may be executed by processor 1007 as it is received, and/or stored in disk drive 1010, or other non-volatile storage for later execution. A database 1032 in storage medium 1031 may be used to store data accessible by the system 1000 via data interface 1033.

In the foregoing specification, the disclosure has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense

What is claimed is:

1. A computer-implemented method for adjusting a window of a non-moving vehicle, the method comprising:
receiving input data from at least one sensor associated with the non-moving vehicle;
determining the input data satisfies activation conditions; and
adjusting a window of the non-moving vehicle in response to the determination that the input data satisfies the activation conditions.

2. The method of claim 1, wherein the at least one sensor is a temperature sensor configured to measure a cabin temperature of the non-moving vehicle, the input data comprises data from the temperature sensor representing the cabin temperature, and the activation conditions comprise the cabin temperature exceeding a threshold temperature.

3. The method of claim 2, wherein adjusting the window comprises opening the window.

4. The method of claim 2, wherein the at least one sensor further comprises a motion sensor, and further comprising receiving input data from the motion sensor associated with the non-moving vehicle configured to detect movement inside the cabin, the input data from the motion sensor representing movement inside the cabin, and the activation conditions comprise detection of movement inside the cabin.

5. The method of claim 4, wherein adjusting the window comprises opening the window.

6. The method of claim 5, wherein adjusting the window comprises opening the window after a threshold amount of time has passed wherein the cabin temperature continues to exceed the threshold temperature.

7. The method of claim 6, further comprising at least one of sounding a horn of the non-moving vehicle, activating a light of the non-moving vehicle, or unlocking a door of the non-moving vehicle.

8. The method of claim 1, wherein the at least one sensor is a motion sensor configured to detect movement inside a cabin of the non-moving vehicle, the input data comprises data from the motion sensor representing movement inside the cabin, and the activation conditions comprise detection of movement inside the cabin.

9. The method of claim 8, wherein adjusting the window comprises opening the window.

10. The method of claim 1, further comprising sending a notification to a user when the window is adjusted, the notification comprising at least one of an email, text message, or alert.

11. The method of claim 1, wherein the at least one sensor is a window position sensor configured to detect a position of the window, the input data comprises data from the window position sensor representing a position of the window, and the activation conditions comprise the window position being closed.

12. A vehicle window control system comprising:
a computer processor to execute a set of program code instructions; and
a memory to hold the set of program code instructions;
wherein the set of program code instructions comprise program code to:
receive, from a temperature sensor associated with a non-moving vehicle, data representing a cabin temperature of the non-moving vehicle;
determine the cabin temperature exceeds a threshold temperature; and
adjust a window of the non-moving vehicle based at least in part on the determination that the cabin temperature exceeds the threshold temperature.

13. The vehicle window control system of claim 12, wherein the program code to adjust the window further comprises program code to open the window.

14. The vehicle window control system of claim 12, wherein the set of program code instructions further comprises program code to:
receive, from a motion sensor associated with the non-moving vehicle, data representing movement inside the cabin of the non-moving vehicle; and
adjust the window based at least in part on the data representing movement inside the cabin.

15. The vehicle window control system of claim 14, wherein the set of program code instructions further comprises program code to open the window after a threshold amount of time has passed after receiving data representing movement inside the cabin of the non-moving vehicle with the cabin temperature continuing to exceed the threshold temperature.

16. The vehicle window control system of claim 14, wherein the set of program code instructions further comprises program code to perform at least one of the following after a threshold amount of time has passed after receiving data representing movement inside the cabin of the non-moving vehicle with the cabin temperature continuing to exceed the threshold temperature: activate a sound component of the non-moving vehicle; activate a light of the non-moving vehicle; open the window of the non-moving vehicle; or unlock a door of the non-moving vehicle.

17. The vehicle window control system of claim 14, wherein the set of program code instructions further comprises program code to send a notification when the window is adjusted, the notification comprising at least one of an email, text message, or alert.

18. The vehicle window control system of claim 12, wherein the set of program code instructions further comprises program code to:
receive input data from a window position sensor associated with the non-moving vehicle configured to detect a position of the window; and
adjust the window based at least in part on the input data from the window position sensor representing the window is closed.

19. A system to reduce cabin temperature of a non-moving vehicle, the system comprising:
a plurality of power windows;
one or more window position sensors configured to sense one or more window positions of respective windows of the non-moving vehicle;
a power window controller configured to control the power windows;
an internal temperature sensor configured to sense a cabin temperature of the non-moving vehicle;
a control module coupled to the window position sensors, the power window controller, and the internal temperature sensor, the control module being configured to:
receive, from the internal temperature sensor, the cabin temperature of the non-moving vehicle;
determine if the cabin temperature exceeds a threshold temperature; and
open the plurality of power windows based at least in part on a determination that the cabin temperature exceeds the threshold temperature.

20. The system of claim 19, further comprising a motion sensor configured to sense movement inside a cabin of the non-moving vehicle, the motion sensor coupled to the control module, wherein the control module is further configured to adjust the plurality of power windows based at least in part on receiving data from the motion sensor representing movement inside the cabin.
